(19) United States
(12) Patent Application Publication
(10) Pub. No.: US 2010/0154648 A1
(43) Pub. Date: Jun. 24, 2010

(54) Steam nozzle assembly for electric coffee machines

(75) Inventor: Luciano Angeletti, Pollenza (MC) (IT)

Correspondence Address: Robert M. Gamson, Esquire;HODES, PESSIN & KATZ, P.A., Suite 400, 901 Dulaney Valley Road, Towson, MD, 21204, US

(73) Assignee: Nuova Simonelli S.P.A.

(21) Appl. No.: 12/653,925

(22) Filed: Dec. 17, 2009

(30) Foreign Application Priority Data
Dec. 18, 2008 (IT) MC2008A000224

(51) Int. Cl. A47J 31/44

(52) U.S. Cl. 99/293

(57) ABSTRACT

An improved steam nozzle assembly for electric coffee machines, having an external pipe (1) where an internal pipe (2) is inserted, through which heated steam flows, and provided with a lower section (2a) externally protruding from the lower end (1a) of the external pipe (1), with a dispenser spout (5) screwed on it, which is axially provided with a blind conduit (5a) where the lower section (2a) of the internal pipe (2), is inserted, the lower end (2b) of which overhangs the nozzles (5b) obtained on the bottom of the conduit (5a) of the spout (5).

### FIELD OF THE INVENTION

The present patent application for industrial invention relates to an improved steam nozzle assembly for electric coffee machines, of the type normally used in bars to make espresso coffee.

### DESCRIPTION OF RELATED ART

This type of electric espresso coffee machines are traditionally provided with a dispenser nozzle of steam heated at approximately 130° C., which is used for rapid heating of drinks, such as water for tea or brews in general, and especially milk for the preparation of foamy cappuccinos.

Said nozzle is generally situated at one end of the coffee machine and is characterised by a sinuous profile comprising a top vertical section connected by a first knee with an intermediate horizontal or sub-horizontal section facing the operator, which is in turn connected by a second knee to a base vertical section ending with the spout where the nozzles that generate jets of heated steam are obtained.

The top vertical section is connected to the machine by means of an articulated connection that allows it to rotate around a vertical axis; normally, said connection is made with a ball-joint that allows said nozzle to oscillate freely, so that the operator can give it the most comfortable or necessary oscillation from time to time, according to the size and shape of the container in which said nozzle is inserted.

The nozzle is normally obtained with a metal pipe that is heated in a few seconds with the passage of heated steam during the operation of the machine. Accordingly, it is coated with a collar made of rubber or other thermo-insulating material in the lower knee, being this the point where the operator normally holds the nozzle between thumb and forefinger to give the desired inclination to it.

Some models of nozzles are made with a teflon® pipe inserted into a metal pipe that remains at room temperature during the operation of the machine due to the insulation action of the internal teflon® pipe, where the heated steam flows, and to the presence of an air gap between the internal pipe and the external pipe.

The advantage of this second model of nozzle is that the operator can grab it in any point without burning his fingers.

Against this advantage and a cleaner aesthetics, being devoid of said rubber collar, the second model of nozzle is impaired by poor reliability from the hygienic viewpoint due to the fact that, although being thin, the air gap between the teflon® internal pipe and the metal external pipe is a place for build-up of impurities entering through the nozzle with a backward ascending movement.

Milk deposits have been especially noted in the air gap after disassembling the spout of this type of nozzles, being practically impossible to clean the air gap. The ascending movement of impurities towards and inside the air gap is caused by the fact that a low depression occurs inside the nozzle as soon the forced supply of heated steam ends, with consequent suction effect inside the spout.

### BRIEF SUMMARY OF THE INVENTION

The purpose of the present invention is to remedy the latter drawback, which is also favoured by the fact that the teflon® pipe is shorter than the metal pipe, so that the lower end of the teflon® pipe is in backward position relative to the lower end of the metal pipe on which the nozzle is screwed.

On the contrary, according to the nozzle assembly of the invention, the lower ending section of the teflon® pipe protrudes from the lower opening of the external metal pipe and is exactly inserted inside the hollow conduit obtained inside the spout and ending with dispensing nozzles at the base.

The spout is provided with an externally threaded piece adapted to be screwed into the lower opening of the metal pipe.

In view of the above, the impurities or drops of liquid that can be possibly sucked inside the spout through the nozzles are automatically conveyed inside the ending section of the teflon® pipe, without any possibility of reaching and entering the air gap, which is hermetically insulated by said nozzles because of the exact sealed coupling between the hollow conduit obtained inside the spout and the ending section of the teflon® pipe that protrudes from the lower end of the metal pipe. At every supply of heated steam the impurities, deposits or drops of liquid that stagnate in the ending section are automatically ejected outside through the same nozzles.

These and other objects of the present invention will become apparent from a reading of the following specification taken in conjunction with the enclosed drawings.

### BRIEF DESCRIPTION OF THE DRAWINGS

For major clarity the description of the nozzle assembly of the present invention continues with reference to the enclosed drawings, which only have an illustrative, not limiting purposes, wherein:

FIG. 1 is a diagrammatic view of the nozzle assembly of the invention;

FIG. 2 is an exploded diagrammatic view of the components of the nozzle assembly of the invention;

FIG. 3 is a cross-sectional view of the lower ending section of the nozzle assembly of the invention, complete with spout, with an axial plane.

### DETAILED DESCRIPTION OF THE INVENTION

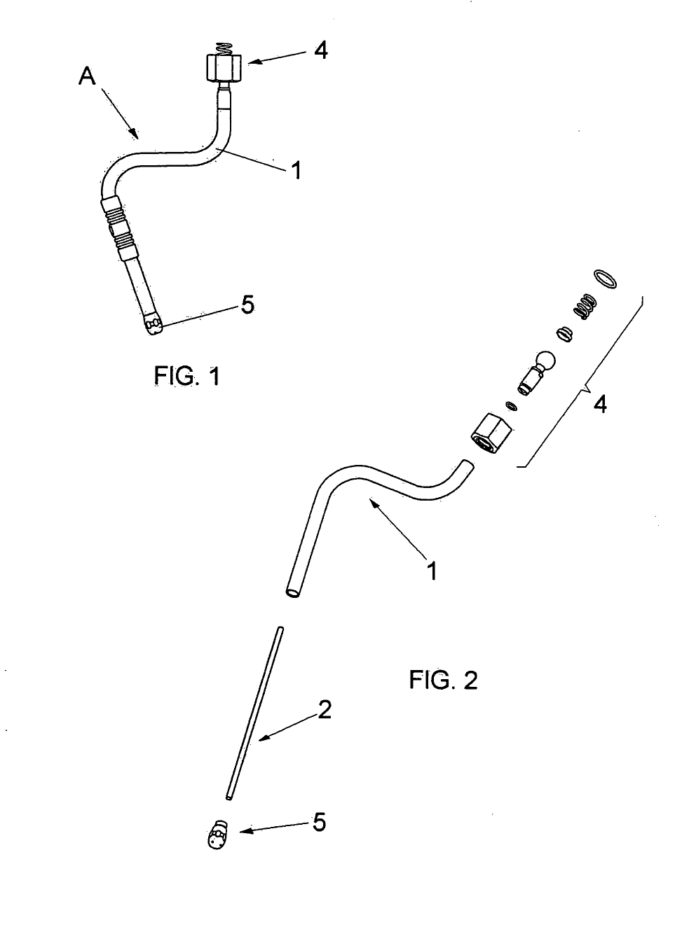

Referring to FIGS. 1 and 2, the nozzle assembly (A) of the invention is of type comprising a metal pipe (1) in which a teflon® pipe (2) is inserted, where heated steam from the boiler of the coffee machine flows.

An air gap (3) is situated between the internal teflon® pipe (2) and the metal pipe (3).

Said nozzle (A) is provided on top with traditional lock means (4), of known type, for articulated fixing to the coffee machine, whereas the nozzle ends with a spout (5) screwed onto the external pipe (1).

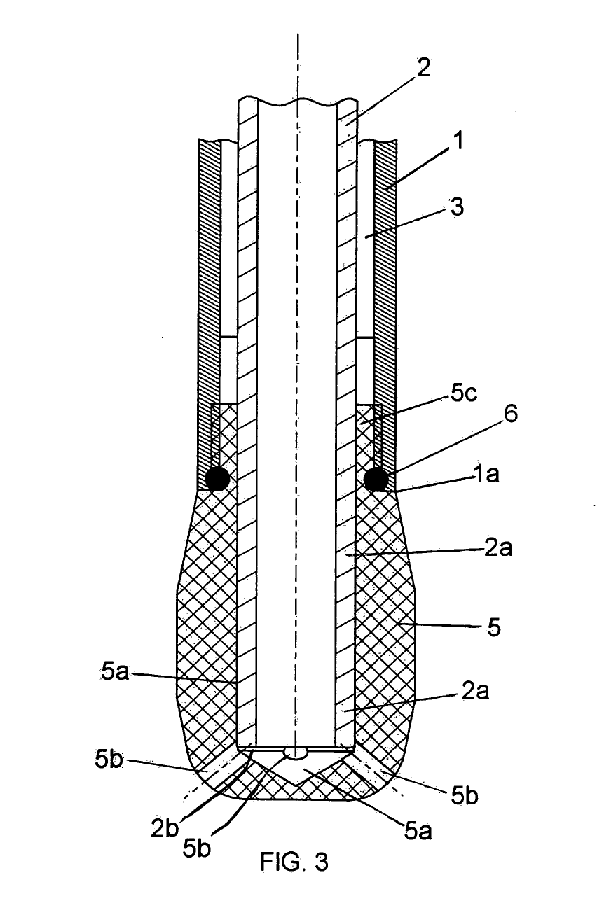

As shown in FIG. 3, the peculiarity of the nozzle assembly of the invention is that it is provided with an internal pipe (2) with lower ending section (2a) protruding outside the lower ending section (1a) of the external pipe (1).

The spout (5) is axially provided with a blind conduit (5a) that exactly receives the protruding section (2a) of the internal pipe (2), the ending section of which (2b) overhangs the nozzles (5b) obtained on the bottom of said conduit (5a). The spout (5) ends on top with a threaded piece (5c) that is screwed inside the external pipe (1), which is suitably provided with internal thread in the lower end (1a).

The threaded piece (5) is internally hollow since the axial conduit (5a) also extends through said piece (5).

Numeral (6) indicates an O-ring situated between spout (5) and external pipe (1). Obviously, many modifications may be made without departing from the basic spirit of the present invention. Accordingly, it will be appreciated by those skilled in the art that within the scope of the appended claims, the invention may be practiced other than has been specifically described herein.

1. Improved steam nozzle assembly for electric coffee machines, of the type comprising:
an external pipe (1) where an internal pipe (2) is inserted, through which heated steam flows;
lock means (4) for articulated fixing of nozzle assembly to coffee machine;
a dispenser spout (5) screwed at lower end of external pipe (1);
nozzle assembly characterised in that
the internal pipe (2) is provided with a lower section (2a) protruding externally from the lower end (1a) of the external pipe (1)
the spout (5) is axially provided with a blind conduit (5a) where the lower section (2a) of the internal pipe (2) is inserted,
nozzles (5b) are obtained on the bottom of the conduit (5a) of the spout, and
the lower end (2b) of the lower section (2a) of the internal pipe (2) overhanging said nozzles (5b) obtained on the bottom of the conduit (5a) of spout.

2. Nozzle assembly according to claim 1, characterised in that the spout (5) ends with a top threaded piece (5c), through which the axial conduit (5a) passes, screwed into the external pipe (1), suitably provided with internal threading in the lower ending section (1a).

3. Nozzle assembly according to claim 1, characterised in that an O-ring (6) is situated between spout (5) and external pipe (1).

4. Nozzle assembly according to claim 1, characterised in that an air gap (3) is situated between external pipe (1) and internal pipe (2).

5. Nozzle assembly according to claim 1, characterised in that the external pipe (1) is a metal pipe.

6. Nozzle assembly according to claim 1, characterised in that internal pipe (2) is made of insulated material, preferably teflon®.
